(19) United States
(12) Patent Application Publication
(10) Pub. No.: US 2007/0153499 A1
(43) Pub. Date: Jul. 5, 2007

(54) ILLUMINATING JEWELRY PIECE

(76) Inventors: Walter Edward Church, BOISE, ID (US); Sam E. J. Chan, HONG KONG (CH)

Correspondence Address: DYKAS, SHAVER & NIPPER, LLP, P.O. BOX 877, BOISE, ID, 83701-0877, US

(21) Appl. No.: 11/539,452

(22) Filed: Oct. 6, 2006

Related U.S. Application Data
(60) Provisional application No. 60/724,547, filed on Oct. 6, 2005.

(51) Int. Cl. F21V 21/08

(52) U.S. Cl. 362/104

(57) ABSTRACT

An illuminating jewelry piece utilizing a plurality of light emitting diodes (LEDs) and translucent stones to provide a bright, generally even patterned light display. Embodiments accomplish this by generally locating the light source (LEDs) equidistant from (between) the light reflecting structures (stones).

### CROSS-REFERENCE TO RELATED APPLICATIONS

This application claims the priority date of provisional application Ser. No. 60/724,547, filed by Oct. 6, 2005, entitled Illuminating Jewelry Piece with the same inventors, the disclosure of which is incorporated herein.

### FIELD OF THE INVENTION

The present invention generally relates to jewelry, and more specifically is related to jewelry with integral light sources for illumination.

### BACKGROUND OF THE INVENTION

There are many different types of jewelry known in the prior art. Some of these types of jewelry have integral lights. However, none are known which provide for even illumination of the piece and/or long battery life. Embodiments of the present invention overcome these problems.

Additional novel features of the invention will be set forth in part in the description which follows, and in part will be apparent to the scope of the invention upon examination of the following.

### SUMMARY OF THE INVENTION

The summary descripts one embodiment of the present invention.

One embodiment of the present invention comprises an illuminating jewelry piece. This illuminating jewelry piece comprising a body, a plurality of translucent stones, a plurality of light emitting diodes (LEDs), a rechargeable battery, an electrical circuit, and a recharge dongle.

The body having at least one display surface that has defined there-through a plurality of holes. Each hole is configured for receiving one of the translucent stones. These translucent stones thus being set in these holes (apertures). The light emitting diodes are spaced apart, and connected to a circuit board or other structure so that each LED is generally located between two of the holes (and is thereby located between two of the stones).

The rechargeable battery is used to power the light emitting diodes. An electrical circuit connects the battery to the light emitting diodes, thereby illuminating the light emitting diodes. The electrical circuit is preferably interrupted by an on/off switch.

The electrical circuit further comprises recharging circuitry for allowing the piece to be recharged. This recharging circuitry further comprising an electrical receptacle.

The recharge dongle is used to recharge the rechargeable battery. The recharge dongle comprising a DC power source, such as an alkaline or rechargeable battery, and an electrical plug configured for connection with the electrical receptacle. Upon plugging the recharge dongle's electrical plug into the electrical circuit's electrical receptacle, the battery held within the recharge dongle recharges the rechargeable battery held within the illuminating jewelry piece's rechargeable battery.

In use, when the switch of the piece is switched to the “On” position, light from the light emitting diodes illuminate the stones, thereby causing the jewelry piece to be illuminated.

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is a top, plan view of one embodiment of the present invention.

FIG. 2 is a first side, plan view of the embodiment of FIG. 1.

FIG. 3 is a front side, plan view of the embodiment of FIG. 1.

FIG. 4 is a second side, plan view of the embodiment of FIG. 1.

FIG. 5 is a back side, plan view of the embodiment of FIG. 1.

FIG. 6 is a bottom side, plan of the embodiment of FIG. 1.

FIG. 7 is a perspective view of the embodiment of FIG. 1.

FIG. 8 is a perspective view of the embodiment of FIG. 1 showing one embodiment of a recharge dongle.

FIG. 9 is an exploded representation of the internal componentry of a second embodiment of the present invention.

FIG. 10 is a partial representation of the components of the present invention as shown in FIG. 9.

FIG. 11 shows a schematical diagram of a third embodiment of the present invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

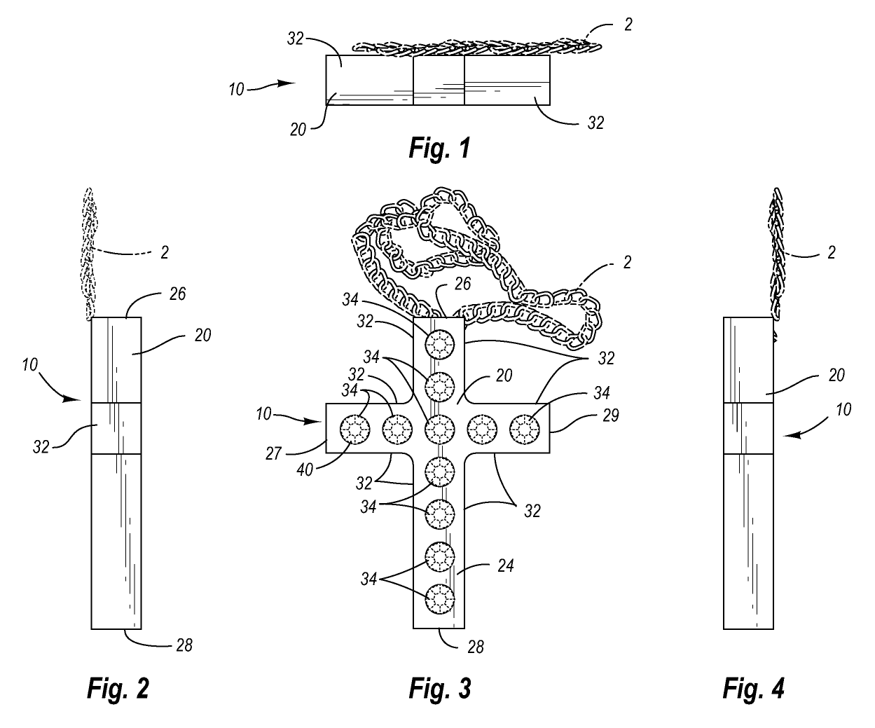

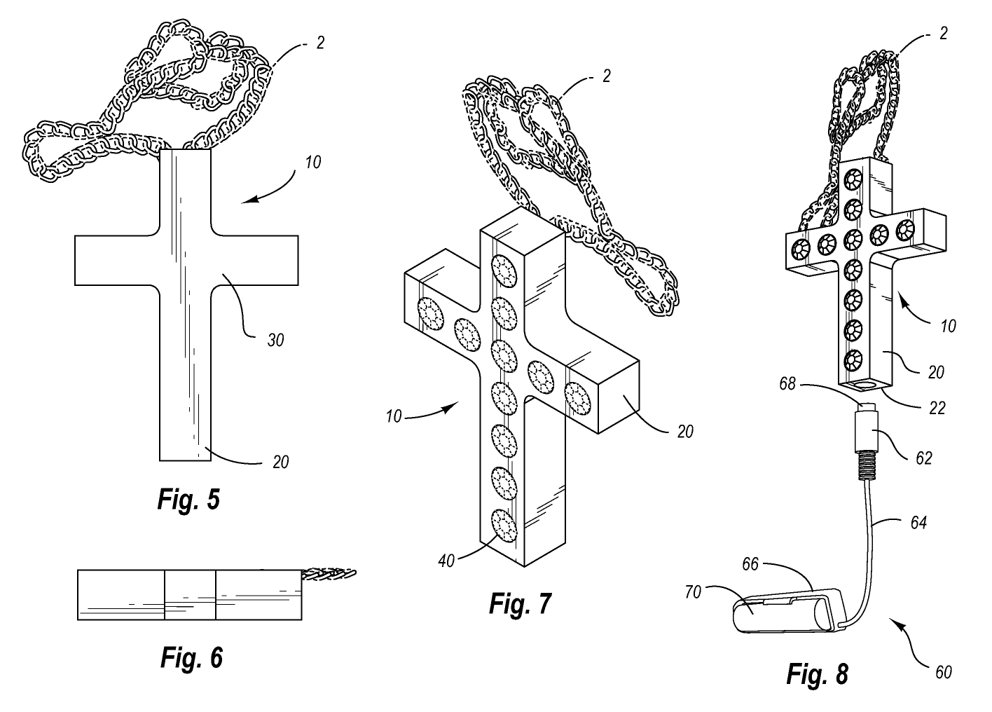

Various embodiments of the present invention are shown in the drawings. Referring initially to FIGS. 1-8, shown is a first embodiment of the present invention. The embodiment being an illuminating jewelry piece 10 having a chain 2 which would be worn around the neck of an individual. While being worn by an individual through use of a chain, pin, or other means/matter is preferred, obviously the present invention can be incorporated into other devices and uses. For instance, it could be used as a decorative display, incorporation into other goods, etc.

The embodiment of the present invention shown in FIGS. 1-8 having a body 20. This body being both decorative as well as serving as a housing into which the components of the present invention reside. In the embodiment shown, the body 20 is generally cross-shaped, having a top side 26, a bottom side 28, a left side 27, a right side 29, as well as a plurality of side walls 32 defined thereupon. The body also having a front surface 24, also known as the “display side” or “display surface,” and a rear cover 30.

While this cross-shape and the resulting sides are shown in the drawings as one representative embodiment of the present invention, other shapes, sizes and matters of construction could likewise be contrived, including but not limited to, triangular shapes, circular shapes, quadrilateral shapes, polygonal shapes and other custom shapes. Thus, the disclosure of this general cross-shape is not intended to be a limitation upon the present invention's disclosure.

Defined into at least one of the surfaces of the present invention (in the case of the embodiments of FIGS. 1-8 referred to as “the display surface 24”) are a plurality of apertures 34. These apertures being, in this embodiment, holes through the display surface 24. The apertures shown in this embodiment are shown to be generally circular, however other shapes and apertures, including round, rectangular, pentagonal, etc. are likewise possible.

A plurality of transparent and/or translucent (herein collectively referred to as translucent) stones are placed into these apertures. They can be held into place through any number of ways, including but not limited to friction fits, settings, adhesives, etc. These stones can be flush or recessed within the apertures. These stones can extend outside of the aperture, or can be fastened into place inside the body so that they generally internally cover the aperture. The stones used can be precious, semi-precious, or man made. In one embodiment the stones are cubic zirconium crystals. It is preferred that they are facetted appropriately to brilliantly shine light reflected there-through.

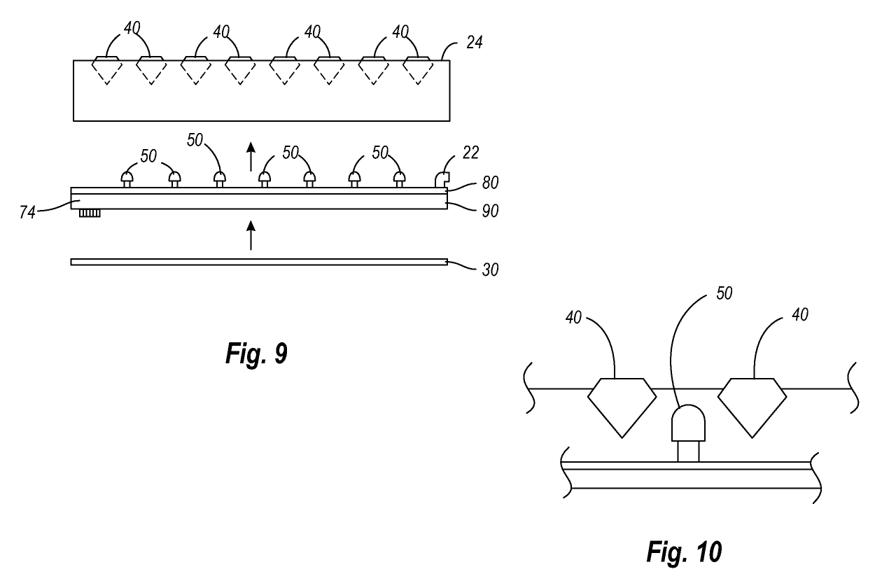

Referring specifically now to FIGS. 8, 9, and 10, shown are two embodiments of the present invention, namely the first embodiment which is shown in FIG. 8, and a second embodiment which is reflected in FIGS. 9 and 10. As can be seen in these Figures, these embodiments of the present invention use a plurality of light emitting diodes (LED). These light emitting diodes 50 are electrically attached to a printed circuit board 80 in the standard manner.

It is preferred that the LEDs 50 be spaced upon the circuit board 80 in an arrangement that would allow them to be placed within the illuminating jewelry piece so that each light emitting diode 50 is generally located between two apertures 34 and/or stones 40 so that the stones are generally equally lighted by light from the LED. This provides for consistent illumination of the piece. This illumination/reflection may be maximized through use of internal reflective surfaces adjacent the LEDs and internal portions of the body. The preferred LEDs are white, however any color of LED can be used. It is preferred that the angle and location of the LEDs be designed to maximize the effect upon the light reflecting structures (stones). Further, it is preferred that the facets cut and/or formed within the stones themselves be designed to maximize the illumination of the device. It is further preferred that the surfaces, internally and externally, of the jewelry piece be designed to radiate illumination and to not absorb light.

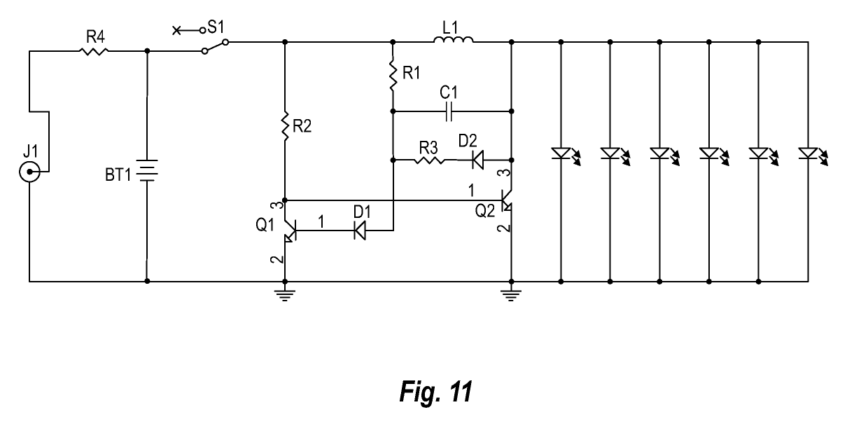

One representation of electrical components which could be used with one embodiment of the present invention can be seen in FIG. 11, a schematic representation of the third embodiment of the present invention.

The illuminating jewelry piece also comprising a rechargeable battery generally represented by call-out number 90 in the drawings. This rechargeable battery working with the circuit board 80 and electrical components of the present invention to power the light emitting diodes 50.

An on/off or other electrical switch 74 may be incorporated therein for allowing the lights of the present invention to be selectively turned on or off. This switch could be a mechanical switch, a photo receptor, or other means of turning the device on and off.

The present invention is a jewelry piece with integral illumination components, these illumination components preferably battery operated. Preferably, this jewelry piece having an on-off switch interconnected between the power source (preferably battery) and the illuminations components (light source). Likewise, the present invention could be turned on/off through use of other means including but not limited to buttons, light sensors, etc. In one example, the switch comprises a light sensor that automatically turns the light source (LED) on when ambient illumination is below a certain preset level. Likewise, the light sensor would automatically turn the light source (LED) off when ambient illumination is above a certain preset level.

By using the referred light source of LEDs (light emitting diodes), the present invention is very efficient at consuming power, thereby allowing the illumination to be provided for maximum amount of time.

The electrical components would preferably be inserted inside of the body 20 and closed with a cover 30 thereby containing all of the componentry of the present invention there-inside. The cover would be attached to the body by traditional means, such as fiction fits, fasteners, adhesives, welds, crimps, etc.

Referring back to FIG. 8, shown is one embodiment of a recharge dongle 60 of the present invention. This recharge dongle 60 having a dongle body 66 for holding a DC power source 70 (such as a battery (alkaline, rechargeable, etc.) therein. This DC power source (battery) is used to recharge the rechargeable battery 90 that is contained within the illuminating jewelry piece. The dongle body 66 having extending therefrom a cable 64 that extends to an electrical plug 22. This electrical plug 22 configured for connection to the electrical connector 68 of the illuminating jewelry piece 10. Upon charging by the recharge dongle, the rechargeable battery 22 of the present invention will be recharged and the recharge dongle can be disconnected from the device so that the device can be displayed and/or worn.

In the following description and in the Figures, like elements are identified with like reference numerals. The use of “or” indicates a non-exclusive alternative without limitation unless otherwise noted. The use of “including” means “including, but not limited to,” unless otherwise noted.

The exemplary embodiments shown in the Figures and described above illustrate but do not limit the invention. It should be understood that there is no intention to limit the invention to the specific form disclosed; rather, the invention is to cover all modifications, alternative constructions, and equivalents falling within the spirit and scope of the invention as defined in the claims. For example, while the exemplary embodiments illustrate a jewelry piece, the invention is not limited to use with jewelry and may be used with other items. While the invention is not limited to use with jewelry, it is expected that various embodiments of the invention will be particularly useful in such devices. Hence, the foregoing description should not be construed to limit the scope of the invention, which is defined in the following claims.

While there is shown and described the present preferred embodiment of the invention, it is to be distinctly understood that this invention is not limited thereto, but may be variously embodied to practice within the scope of the following claims. From the foregoing description, it will be apparent that various changes may be made without departing from the spirit and scope of the invention as defined by the following claims.

What is claimed is:

1. An illuminating jewelry piece, said piece comprising:
a body having a display surface, said display surface defining a plurality of holes there-through, said holes regularly spaced apart;
a plurality of translucent stones, set stones set in said holes;
a plurality of light emitting diodes, said light emitting diodes spaced apart so that said each diode is generally between two of said holes;
a battery; and
an electrical circuit connecting said battery to said light emitting diodes thereby illuminating said light emitting diodes.

2. The illuminating jewelry piece of claim 1, wherein said battery is rechargeable.

3. The illuminating jewelry piece of claim 1, wherein said electrical circuit further comprising recharging circuitry for allowing said rechargeable battery to be recharged.

4. The illuminating jewelry piece of claim 1, wherein said recharging circuitry further comprising an electrical receptacle.

5. The illuminating jewelry piece of claim 1, further comprising a recharge dongle for recharging said battery, said recharge dongle comprising a DC power source and an electrical plug configured for connection with said electrical receptacle.

6. The illuminating jewelry piece of claim 1, wherein said battery is rechargeable.

7. The illuminating jewelry piece of claim 6, wherein said electrical circuit further comprising recharging circuitry for allowing said rechargeable battery to be recharged, wherein said recharging circuitry further comprising an electrical receptacle.

8. The illuminating jewelry piece of claim 7, further comprising a recharge dongle for recharging said battery, said recharge dongle comprising a DC power source and an electrical plug configured for connection with said electrical receptacle.

9. The illuminating jewelry piece of claim 1, wherein said electrical circuit is interrupted by a switch.

10. An illuminating jewelry piece, said piece comprising:
a body having a display surface, said display surface defining a plurality of holes there-through, said holes regularly spaced apart;
a plurality of translucent stones, set stones set in said holes;
a plurality of light emitting diodes, said light emitting diodes spaced apart so that said each diode is generally between two of said holes;
a rechargeable battery;
an electrical circuit connecting said battery to said light emitting diodes thereby illuminating said light emitting diodes, said electrical circuit further comprising recharging circuitry for allowing said rechargeable battery to be recharged

11. The illuminating jewelry piece of claim 10, wherein said recharging circuitry further comprising an electrical receptacle.

12. The illuminating jewelry piece of claim 10, further comprising a recharge dongle for recharging said battery, said recharge dongle comprising a DC power source and an electrical plug configured for connection with said electrical receptacle

13. The illuminating jewelry piece of claim 10, wherein said electrical circuit is interrupted by a switch.

14. An illuminating jewelry piece, said jewelry piece comprising:
a body having a display surface, said display surface defining a plurality of holes there-through, said holes regularly spaced apart;
a plurality of translucent stones, set stones set in said holes;
a plurality of light emitting diodes, said light emitting diodes spaced apart so that said each diode is generally between two of said holes;
a rechargeable battery;
an electrical circuit connecting said battery to said light emitting diodes thereby illuminating said light emitting diodes, said electrical circuit interrupted by a switch, said electrical circuit further comprising recharging circuitry for allowing said rechargeable battery to be recharged, said recharging circuitry further comprising an electrical receptacle; and
a recharge dongle for recharging said battery, said recharge dongle comprising a DC power source and an electrical plug configured for connection with said electrical receptacle;
wherein light from said light emitting diodes illuminates said stones.
